(19) United States
(12) Patent Application Publication
(10) Pub. No.: US 2018/0101341 A1
(43) Pub. Date: Apr. 12, 2018

(54) IMAGE FORMING DEVICE, IMAGE FORMING METHOD, AND NON-TRANSITORY RECORDING MEDIUM

(71) Applicants: Tomokazu TSUCHIYA, Kanagawa (JP); Kazuya TANI, Kanagawa (JP); Daiki SAKURADA, Kanagawa (JP); Masaki NAKAMURA, Kanagawa (JP)

(72) Inventors: Tomokazu TSUCHIYA, Kanagawa (JP); Kazuya TANI, Kanagawa (JP); Daiki SAKURADA, Kanagawa (JP); Masaki NAKAMURA, Kanagawa (JP)

(73) Assignee: Ricoh Company, Ltd., Tokyo (JP)

(21) Appl. No.: 15/707,011

(22) Filed: Sep. 18, 2017

(30) Foreign Application Priority Data
Oct. 6, 2016 (JP) 2016-198483
Jan. 24, 2017 (JP) 2017-010448

(51) Int. Cl. G06F 3/12; H04N 1/00

(52) U.S. Cl. CPC G06F 3/1234; H04N 1/32667; H04N 1/00915

(57) ABSTRACT

An image forming device includes a memory, a memory controller, an error detector, a determiner, a print controller, a display, and a display controller. The memory controller acquires print information transmitted from an external device, and stores and controls the print information in the memory. The error detector detects a print error after start of printing of the print information. The determiner determines whether to execute sheet recovery processing to reprint a page in which the print error has occurred. The print controller controls a printing unit to execute the sheet recovery processing with the print information stored in the memory when a determination result to execute the sheet recovery processing is obtained. The display controller displays on the display a message indicating that the sheet recovery processing is not executed when a determination result not to execute the sheet recovery processing is obtained.

### CROSS-REFERENCE TO RELATED APPLICATIONS

This patent application is based on and claims priority pursuant to 35 U.S.C. § 119(a) to Japanese Patent Application Nos. 2016-198483, filed on Oct. 6, 2016, and 2017-010448, filed on Jan. 24, 2017 in the Japan Patent Office, the entire disclosure of each of which is hereby incorporated by reference herein.

### BACKGROUND

### Technical Field

Aspects of the present disclosure relates to an image forming device, an image forming method, and a non-transitory recording medium storing program codes that cause a computer to execute the method.

### Related Art

Recently, image forming devices are known that have sheet recovery function. In this image forming device, when printing stops midway due to occurrence of a print error such as a paper clogged during conveyance, after the clogged paper is removed and the image forming device recovers from the error, printing resumes from print information stored in the memory printing of which has not been completed. As a result, even when an error occurs, printing can be completed without causing a missing page of a printed matter.

### SUMMARY

In an aspect of the present disclosure, there is provided an image forming device that includes a memory, a memory controller, an error detector, a determiner, a print controller, a display, and a display controller. The memory controller acquires print information transmitted from an external device, and stores and controls the print information in the memory. The error detector detects a print error after start of printing of the print information. The determiner determines whether to execute sheet recovery processing to reprint a page in which the print error has occurred. The print controller controls a printing unit to execute the sheet recovery processing with the print information stored in the memory when a determination result to execute the sheet recovery processing is obtained. The display controller displays on the display a message indicating that the sheet recovery processing is not executed when a determination result not to execute the sheet recovery processing is obtained.

In another aspect of the present disclosure, there is provided an image forming method that includes acquiring print information transmitted from an external device and storing the print information in a memory; detecting a print error after start of printing of the print information; determining whether to execute sheet recovery processing to reprint a page in which the print error has occurred; controlling a printing unit to execute the sheet recovery processing with the print information stored in the memory when a determination result to execute the sheet recovery processing is obtained; and displaying on a display a message indicating that the sheet recovery processing is not executed when a determination result not to execute the sheet recovery processing is obtained.

In still another aspect of the present disclosure, there is provided a non-transitory recording medium storing program codes that cause a computer to execute an image forming method. The image forming method includes acquiring print information transmitted from an external device and storing the print information in a memory; detecting a print error after start of printing of the print information; determining whether to execute sheet recovery processing to reprint a page in which the print error has occurred; controlling a printing unit to execute the sheet recovery processing with the print information stored in the memory when a determination result to execute the sheet recovery processing is obtained; and displaying on a display a message indicating that the sheet recovery processing is not executed when a determination result not to execute the sheet recovery processing is obtained.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a hardware configuration diagram of an image forming device according to a first embodiment;

FIG. 2 is a functional block diagram of respective functions implemented by executing an image forming program included in the image forming device;

FIG. 3 is a flowchart illustrating a flow of printing processing of the image forming device according to the first embodiment;

FIG. 4 is a diagram illustrating a format of print information handled by the image forming device according to the first embodiment;

FIG. 5 is a flowchart illustrating a flow of determination operation as to whether to perform sheet recovery in the image forming device according to the first embodiment;

FIGS. 6A to 6C are schematic diagrams for explaining storing operation of band data in a RAM at occurrence of a jam in the image forming device according to the first embodiment;

FIG. 7 is a flowchart illustrating a flow of a sheet recovery operation of the image forming device according to the first embodiment;

FIGS. 8A and 8B are diagrams illustrating an example of an error message displayed when the sheet recovery operation is not performed in the image forming device according to the first embodiment;

FIG. 9 is a flowchart illustrating a flow of determination operation as to whether to perform sheet recovery in an image forming device according to a second embodiment;

FIG. 10 is a diagram illustrating an example of a determination table used for determining whether to perform sheet recovery in the image forming device according to the second embodiment;

FIG. 11 is a flowchart illustrating a flow of determination operation as to whether to perform sheet recovery in an image forming device according to a third embodiment;

FIG. 12 is a diagram illustrating an example of a list of recovery no good (NG) modes;

FIG. 13 is a diagram illustrating an example of a determination table of sheet recovery;

FIG. 14 is a flowchart illustrating a flow of operation according to a determination result as to whether to perform sheet recovery in an image forming device according to a fourth embodiment;

FIG. 15 is a diagram illustrating an example of a message inquiring whether to resume printing from a next page when sheet recovery is not performed;

FIG. 16 is a diagram illustrating an example of a message displayed when a user designates to cancel printing;

FIG. 17 is a flowchart for explaining operation of erasing band data of a print job in which a print error has occurred from a ROM when cancellation of printing from a next page is designated;

FIGS. 18A to 18C are schematic diagrams for explaining operation of erasing, from a RAM, a print job in which a print error has occurred and of which printing has been designated to be canceled by a user;

FIG. 19 is a flowchart illustrating a flow of processing of enabling printing of “a missing-page indication page” in an image forming device according to a fifth embodiment;

FIG. 20 is a diagram illustrating an example of printed band data for printing a missing-page indication page;

FIGS. 21A to 21D are schematic diagrams illustrating a flow of storing band data for printing a missing-page indication page in a RAM; and

FIGS. 22A to 22C are schematic diagrams illustrating how band data for printing a missing-page indication page is erased from the RAM after printing.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, a multifunction peripheral as an embodiment will be described.

### First Embodiment

(Hardware Configuration of Image Forming Device)

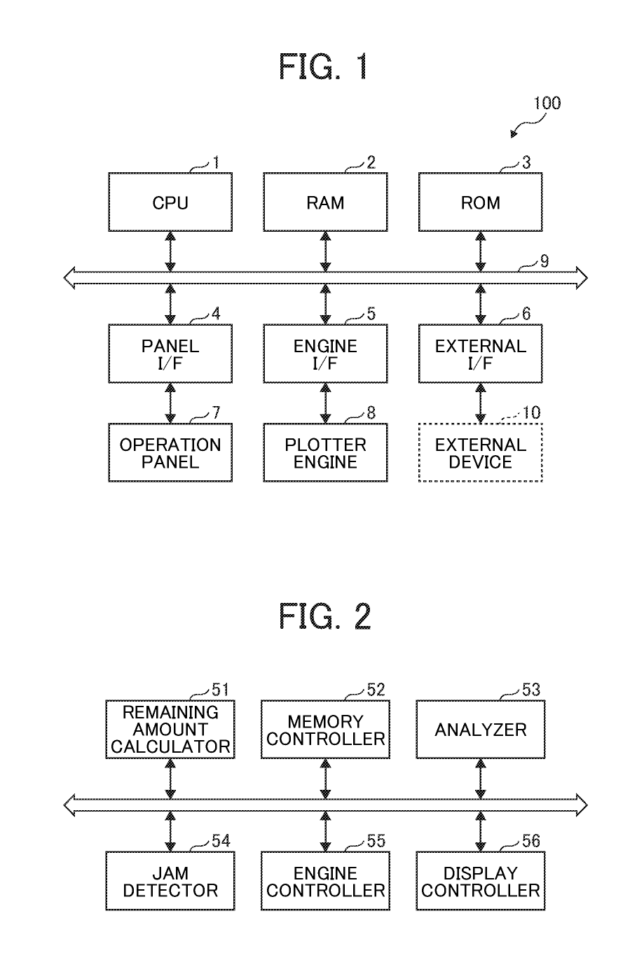

First, FIG. 1 is a diagram illustrating a hardware configuration of an image forming device 100 according to a first embodiment. As illustrated in FIG. 1, the image forming device 100 includes a central processing unit (CPU) 1, a random access memory (RAM) 2, a read only memory (ROM) 3, a panel interface (panel I/F) 4, an engine I/F 5, and an external I/F 6. The CPU 1 through to the external I/F 6 are mutually coupled via a bus line 9. The panel I/F 4 is coupled to an operation panel 7. The engine I/F 5 is coupled to a plotter engine 8. The external I/F 6 is coupled to an external device 10. The plotter engine 8 is an example of a printing unit.

The ROM 3 stores a boot program for activating the image forming device, an image forming program which will be described later, and various types of data. The RAM 2 temporarily stores various programs, print information, and other information read from the ROM 3. The RAM 2 stores print information transmitted from the external device 10. The RAM 2 is an example of a memory. The RAM 2 is a page memory that stores print information including divided print information (band data), in which print information for one page is divided into a plurality of pieces and transmitted, page information, etc.

The panel I/F 4 is an interface for operating the operation panel 7. The panel I/F 4 uses, for example, UART communication (asynchronous serial communication) to transmit a message to be displayed on a display screen to the operation panel 7. The panel I/F 4 further acquires a key operation notification or the like input by a user operating the operation panel 7. The operation panel 7 has a display function to display a message to a user such as a message at the time of a print error which will be described later and an operation detecting function to detect input operation by the user.

The engine I/F 5 is an interface for transmitting and receiving information to and from the plotter engine 8. The engine I/F 5 uses, for example, RS-232C communication to transmit and receive information to and from the plotter engine 8. The plotter engine 8 prints an image or the like on a paper on the basis of print information transmitted from the engine I/F 5. The plotter engine 8 notifies a state of the engine to the engine I/F 5. For example, the engine I/F 5 is provided with a jam notification notifying that a paper is jammed in the plotter engine 8, a cover open notification notifying that a cover of the plotter engine 8 is open, or other notifications. Note that a paper jam after the start of printing is an example of a print error. Other than this, print errors include an open cover when the main body cover of the image forming device is opened after the start of printing, toner runout when a toner runs out after the start of printing, and other errors.

In the description of this embodiment, it is assumed that the image forming device includes the plotter engine 8; however, another image forming engine such as a copy engine or a scanner engine may be included.

The image forming device described in embodiments of the present disclosure may include an inkjet device. An inkjet device is an image forming device that forms an image by jetting an ink (liquid droplet) from an inkjet head onto a paper. An outline of image formation by a print job in such an inkjet device will be described. When a user commands a print job, an external device (such as a PC) first transmits print information to the inkjet device using a printer driver for the inkjet device. The print information is analyzed and decomposed into job information, page information, print images, and the like in the inkjet device. The print images are further divided into a plurality of divided pieces of print information (band data). The inkjet device forms an image for scanning of one time (one row) on a paper for each piece of band data using an inkjet head and repeats this operation until the completion of printing. Note that it is also possible to use a method in which the external device divides a print image into pieces of band data to transmit the band data, and the inkjet device receives the band data to print.

In an image forming device having such a configuration, with a background (cause) that a low-capacity memory (page memory implemented by a RAM) is included due to cost reduction, a situation occurs where the disadvantage solved by embodiments of the present disclosure is likely to occur, that is, a situation occurs where not all band data for one page is accommodated in the memory. Note that, in the image forming device, a laser printer or a multifunction peripheral other than an inkjet device may print using band data as described above.

The external I/F 6 is an interface for transmitting and receiving print information between the image forming device and the external device 10. The external I/F 6 receives print information transmitted from the external device 10 using universal serial bus (USB) communication, for example. The external device 10 is a device that generates print information in a format that can be printed by the plotter engine 8 from electronic data such as a portable document format (PDF) (registered trademark) file. The external device 10 corresponds to, for example, a personal computer device or a smart device.

(Software Configuration of Image Forming Device)

FIG. 2 is a diagram illustrating a software configuration of the image forming device. The CPU 1 executes an image forming program stored in, for example, the ROM 3 or other places to implement respective functions illustrated in FIG. 2. Specifically, the CPU 1 executes the image forming program to implement respective functions of a remaining amount calculator 51, a memory controller 52, an analyzer 53, a jam detector 54, an engine controller 55, and a display controller 56. The analyzer 53 is an example of a determiner. The jam detector 54 is an example of an error detector. The engine controller 55 is an example of a print controller.

Note that although the components from the remaining amount calculator 51 through to the display controller 56 are implemented by software by the image forming program, a part or all of the components be implemented by hardware such as an integrated circuit (IC).

The image forming program may be recorded in a recording medium readable by a computer device such as a CD-ROM, a flexible disk (FD) in a file in an installable format or an executable format and thereby provided. Alternatively, the program may be recorded in a recording medium readable by a computer device such as a CD-R, a digital versatile disk (DVD), a Blu-ray (registered trademark) disk, a semiconductor memory and thereby provided. Further alternatively, the image forming program may be provided by a form of installing via a network such as the Internet. Further alternatively, the image forming program may be provided by being incorporated in a ROM or the like in the device in advance.

When the image forming device acquires print information (including divided print information) from the external device, the remaining amount calculator 51 monitors a free space of the RAM 2 for storing the print information and calculates a storable size of the print information. The memory controller 52 performs operation of recalling print information stored in the RAM 2 in order to store print information in the RAM 2 and to perform sheet recovery processing. This is for performing the reprinting processing on the basis of the same print information as print information stored for the initial printing when sheet recovery is performed. The analyzer 53 analyzes the format of print information, divides the print information into print setting information, print image, etc., or identifies the type of the print setting information.

The jam detector 54 monitors the conveyance state or the like of a paper on the basis of the conveyance detection output or the like of a paper sensor notified by the plotter engine 8, and when a paper jam occurs in a conveyance path or the like, the jam detector 54 notifies as such to a user and changes internal processing to processing at the time of jam occurrence. Specifically, the jam detector 54 monitors the amount of rotational movement of a motor that moves the conveyance path for conveying a paper to be printed and a sensor output of a motion sensor that detects a movement position of a paper. When a sensor output corresponding to the amount of rotational movement of the motor cannot be obtained, the jam detector 54 detects occurrence of a jam such as a paper jam. That is, when the motion sensor does not detect presence of a paper even though the amount of rotational movement of the motor indicating that a paper has been conveyed to a position where the motion sensor is provided is obtained, there is a possibility that the paper is clogged on a conveyance path before the motion sensor. In such a case, the jam detector 54 detects occurrence of a jam.

Furthermore, the jam detector 54 detects that the paper clogged in the conveyance path or the like has been removed and that a state where a paper can be normally conveyed has been achieved, notifies a user of recovery to a state where printing can be performed, and changes internal processing to processing at the time of recovering from the jam state. Although this is merely an example, the jam detector 54 requests the display controller 56 to generate a notification screen indicating occurrence of a jam or recovery from a jam when the jam occurs or recovering from the jam state. The display controller 56 displays on the operation panel 7 the notification screen indicating occurrence of the jam or recovery from the jam.

The engine controller 55 controls the plotter engine 8. At the time of normal printing, the engine controller 55 transmits print information sequentially read from the RAM 2 by the memory controller 52 to the plotter engine 8. When occurrence of a jam is detected by the jam detector 54, the memory controller 52 stops reading control of print information since normal printing cannot be continued.

Furthermore, in the case of the image forming device according to the first embodiment, different processing is executed depending on whether to perform sheet recovery processing at the time of recovering from a jam. When sheet recovery is executed, the memory controller 52 reads the first print information of the page printing of which has not been completed from the RAM 2 and transmits the print information to the plotter engine 8. On the other hand, when sheet recovery is not executed, a message indicating occurrence of a jam is displayed on the operation panel 7 as will described later. Note that when sheet recovery is not executed, print job in which the jam has occurred may be canceled. Furthermore, printing may be resumed from the first print information of the next page of the page printing of which has not been completed.

(Normal Printing Operation)

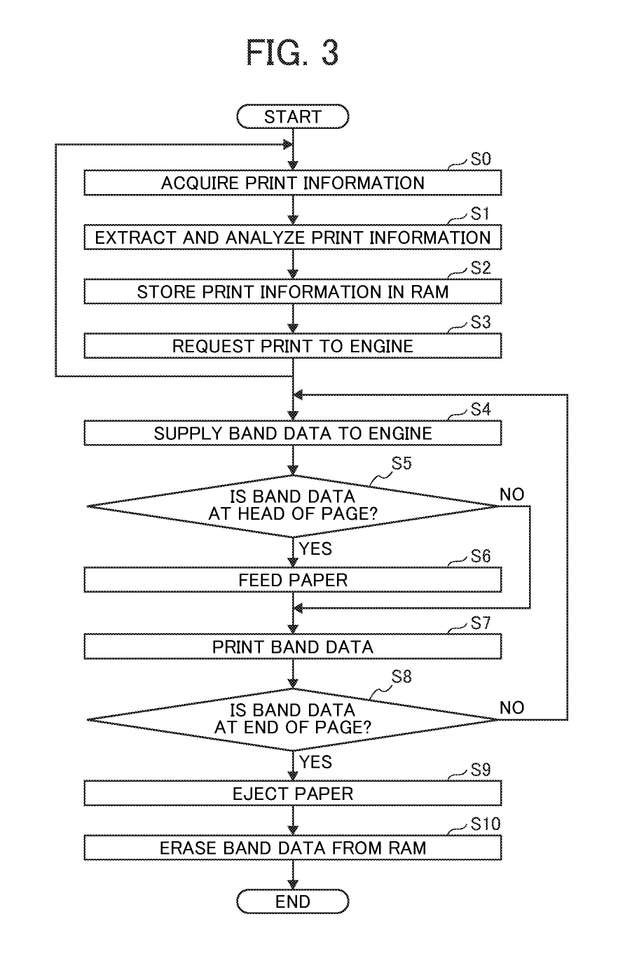

Next, the flow of normal printing operation in the image forming device according to the first embodiment will be described with reference to a flowchart of FIG. 3. First, the memory controller 52 acquires print information (including print setting information and divided print information (band data) divided into a plurality of pieces for each page, etc.) from the external device such as a personal computer device (step S0), then extracts and analyzes the print setting information (step S1), and stores the print setting information in a memory such as the RAM 2 (step S2). The engine controller 55 issues a print request to the plotter engine 8 (step S3), and supplies the band data read from the RAM 2 by the memory controller 52 to the plotter engine 8. Note that a print image in the print information may be divided by the external device and transmitted as divided print information or may be divided by the image forming device after the print image has been received in the image forming device.

The plotter engine 8 determines whether the supplied band data corresponds to a head of a page (step S5), and when it is determined that the band data corresponds to a head of a page (determined by order information “001” of a header of each of the band data, which will be described later) (step S5: Yes), the plotter engine 8 feeds a paper (step S6). Then in step S7, printing of band data is started (image is formed on a paper with one piece of band data as one time of scanning). When the plotter engine 8 determines that the supplied band data does not correspond to a head of a page (determined by not having the order information “001” of a header of each of the band data, which will be described later) (step S5: No), the plotter engine 8 continues printing (step S6).

Next, the plotter engine 8 continues printing to determine whether printing of band data corresponding to an end of a page has been completed (determine by page end information “end of band” of a header of each band data, which will be described later) (step S8). If it is determined that printing of band data corresponding to an end of a page has not been completed (step S8: No), the processing returns to step S4. Band data is sequentially printed until printing of the band data corresponding to an end of a page is completed.

On the other hand, if it is determined by the plotter engine 8 that printing of band data corresponding to an end of a page has been completed (step S8: Yes), the printed paper is ejected (step S9). When the paper is ejected, the memory controller 52 erases the printed band data stored in the RAM 2 (step S10), and terminates the processing of the flowchart of FIG. 3. Note that a print job is completed when printing of the last band data of the last page is completed and the ejection of all the pages is completed.

(Configuration of Print Information)

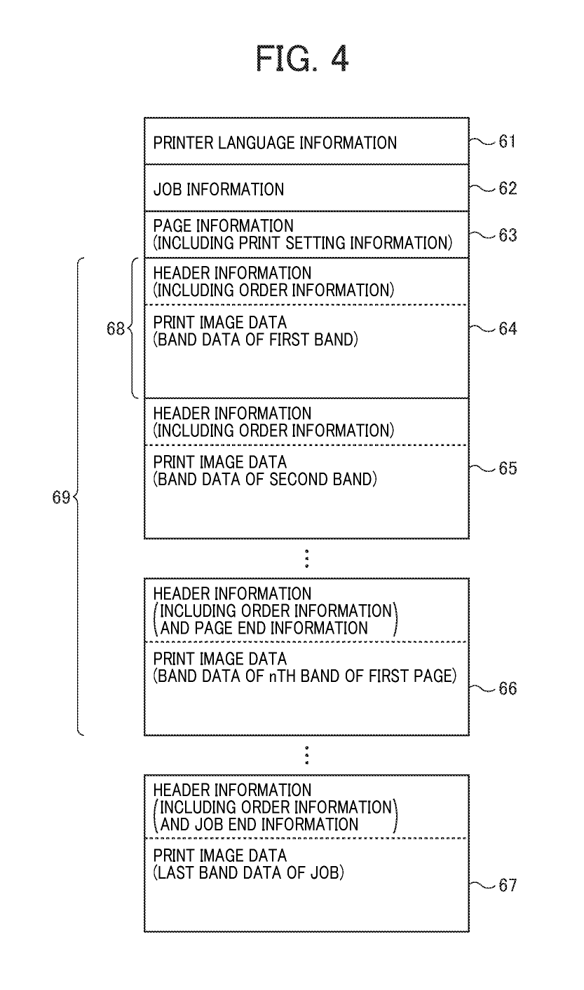

Next, a configuration of print information is illustrated in FIG. 4. FIG. 4 is a diagram conceptually illustrating print information sequentially stored in the RAM 2. As illustrated in FIG. 4, print information includes printer language information 61, job information 62, page information 63, and print image data 64, 65, 66, and 67.

In the printer language information 61, the type of printer language is described as a character string. That is, a format of print information which can be handled by the image forming device varies depending on the type of the plotter engine 8. Therefore, the printer language information 61 indicates a format and other information of print information subsequent to the printer language information 61. For example, in the case of print information acquired from a personal computer device, a character string such as “RPCR” is described as the printer language information 61. In the case of the print information acquired from a terminal device, a character string such as “RaS2” is described as the printer language information 61. Note that the printer language information 61 is not actually printed.

As the job information 62, information unique to the print job such as a job name, a name of the printed file, unique identification information of the job is described. A part of the information of the job information 62 is displayed on the operation panel 7.

In the page information 63, print setting information related to conditions of print setting necessary for printing of each page, formal information of a print image, and the like as described below for example are described.

1. Print setting information includes the following various setting information and other information: *Print mode: print mode based on the type of data such as a photograph mode, a normal document mode (printing of word file, PDF, screen displaying a Web browser, etc.), etc.; *Type of printing paper: plain paper, photo paper, glossy paper, thin paper, etc.; *Print quality: image quality priority, standard, speed priority, etc.; *Number of colors of printing: monochrome, two colors, full color, etc.; and *Size of printing paper: A4, A3, letter, sheet feeding tray to use, etc.

2. Formal information of a print image includes format information of the print image exemplified below: *Total number of printed pages; *Height of paper (longitudinal length of one page) based on the paper size; *Width (lateral length of one page); *Resolution of print image; and *Height of band (length of one band in the longitudinal direction of a paper).

The image forming device extracts, from the page information 63, and uses information necessary for printing. Moreover, depending on the type of printer language, the size of the image data 64 and 65 can be calculated on the basis of format information of a print image described in the page information 63. In this case, the size of image (data volume) of band data is obtained as: width of paper×length of band×resolution. A data volume of one page can be calculated by the width of paper×the height of paper×resolution, for example.

The print image data 64, 65 are obtained by dividing image data of one page into a plurality of pieces of image data. Each piece of the image data formed by being divided results in as the “band data” described above. Following the page information 63, each piece of band data is described in the print information such as band data of the first band, band data of the second band, . . . and the like. Note that the print image data 66 includes band data of an nth band of the first page and indicates the last band data of the page. The print image data 67 indicates the last band data of the last page of the print job. A symbol 69 denotes print image data for one page.

Note that header information is added to each of the band data. In header information, order information in which a page number indicating a numbered order of the page and band identification information (band ID) indicating the order of the band data are associated is described. For example, order information such as “1-001” for the first band data of the first page, “1-002” for the second band data of the first page, and “2-003” for the third band data of the second page enables knowing a numbered order of a band and a page number of all band data. A number “001” such as in 1-001 and 2-001 functions as start information indicating band data at the head of a page. Furthermore, the last band data of each page such as the print image data 66 has page end information indicating the end of the page such as “end of band” in the header. The last band data of the last page of the print job such as the print image data 67 may have job end information indicating that the band data is the last data of the job such as “end of job” in the header. Note that as illustrated in FIG. 4, a combination of each print image in one page and header information of the print image may be defined as “divided print information” 68. Note that divided print information may be referred to as band data. Furthermore, out of print information, the entire print image data to be printed as one job may be defined as “the entire print image data”.

When acquiring print information from a personal computer device or the like, the image forming device first acquires the printer language information 61, the job information 62, and the page information 63 and thereafter acquires the band data of the first band, the band data of the second band, . . . in the order mentioned. The image forming device recognizes print information acquired during the period from acquisition of the page information 63 until the acquisition of next page information 63 as print information for one page and performs print control. Note that print information of the last page is added with a command indicating that the page is the last page. The image forming device completes the printing operation after completing printing of the print information added with the command indicating the last page. Alternatively, the total number of print pages of the format information may be compared with the number of pages of the order information to determine that a print image being printed is included in the last page.

(Determination Operation of Sheet Recovery)

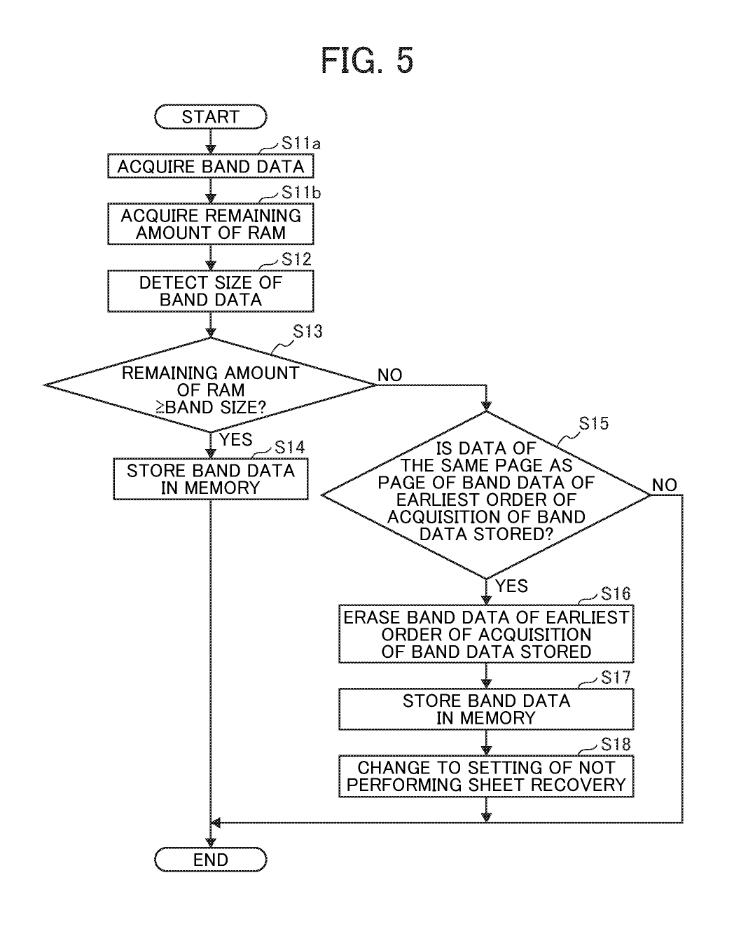

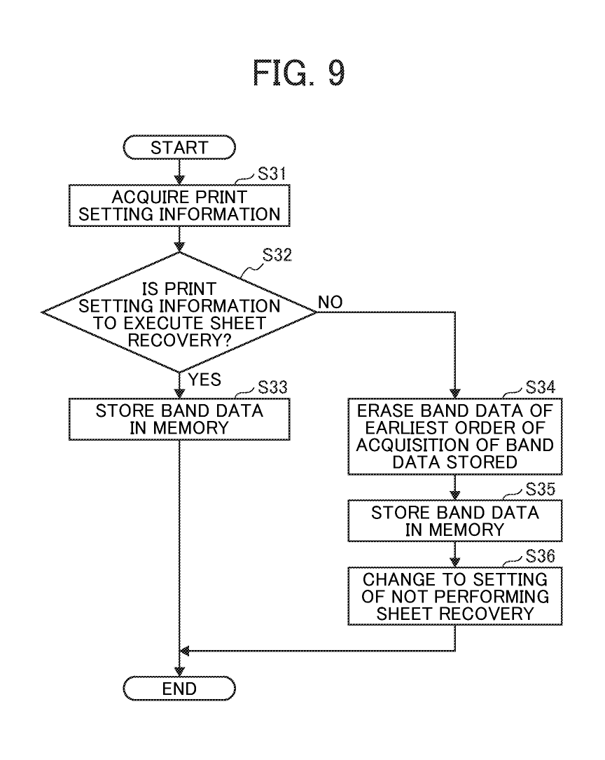

Next, in the image forming device according to the first embodiment, for example, determination of sheet recovery is performed for example at the following timings: *When checking the remaining amount of the RAM 2 for each band data at the time of acquisition of divided print information (band data) (operation illustrated in a flowchart of FIG. 5); and *When acquiring print setting information from the page information 63 in the print information (operation illustrated in a flowchart of FIG. 9. Descriptions will be provided in the second embodiment).

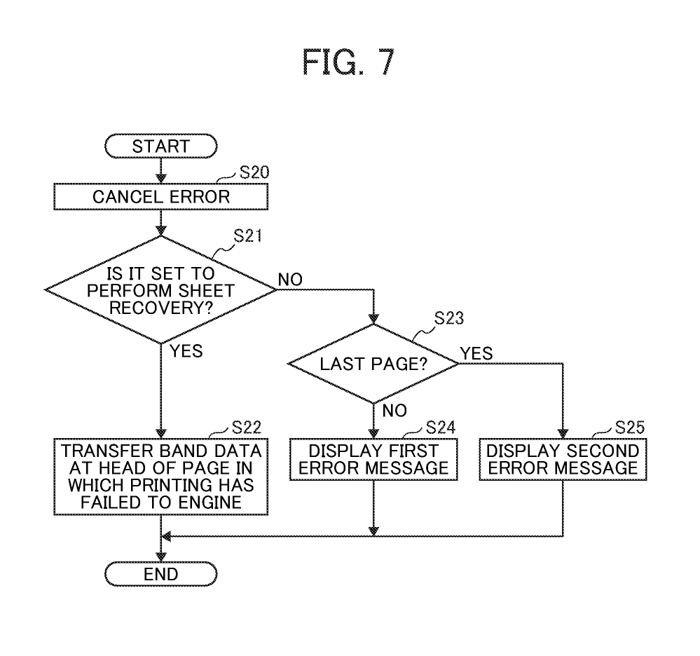

On the basis of this determination result, whether to perform sheet recovery is determined in advance (to set or to cancel setting), and when a print error such as jam is released, sheet recovery operation is executed (operation illustrated in a flowchart of FIG. 7). Although this is merely an example, in the case of the image forming device according to the first embodiment, “setting to execute sheet recovery” is made as the default setting. The sheet recovery information indicating whether to execute sheet recovery is stored in a memory such as the RAM 2 or the ROM 3. As will be described later, when canceling a jam, the CPU 1 refers to the sheet recovery information stored in the memory and determines whether to execute the sheet recovery operation.

First, determination operation of sheet recovery will be described with reference to the flowchart of FIG. 5. Note that the determination operation of sheet recovery illustrated in the flowchart of FIG. 5 is executed in units of print jobs. The flowchart of FIG. 5 is a sub-flowchart of FIG. 3 (flowchart of the overall operation) and is executed after acquiring print information in step S0 of FIG. 3 or after storing print information including band data in the RAM 2 in step S2. First, band data is acquired in step S11a of the flowchart of FIG. 5. In step S11b, the remaining amount calculator 51 illustrated in FIG. 2 detects the remaining amount (surplus area) of a memory area of the RAM 2 which is an example of the memory for storing band data. The remaining amount calculator 51 calculates a difference between the entire memory capacity of the RAM 2 and the size of a memory area currently used by storing print information to calculate the surplus area of the RAM 2.

In step S12, the analyzer 53 detects the data size of band data acquired at the occurrence of a jam. The analyzer 53 calculates the data size of the band data from the print information included in the page information 63 of the print information described with reference to FIG. 4. The analyzer 53 calculates, for example, “paper size (inch)×resolution (dpi)×height of the band (line)” from the paper size, the resolution, and the height information of one band included in the page information 63 in the print information to calculate the data size of the band data. Furthermore, when image data is included in each band data, the analyzer 53 may read the included image data to detect the data size.

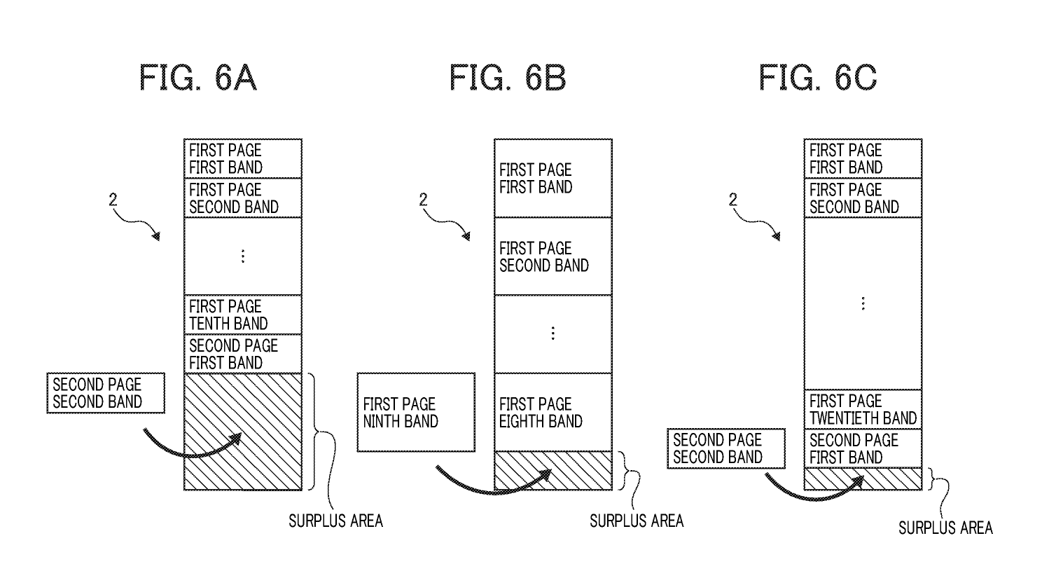

Next in step S13, the analyzer 53 determines whether the data size of the band data acquired at the occurrence of the jam is less than or equal to the surplus area of the RAM 2. FIGS. 6A to 6C are diagrams illustrating relationship between a surplus area of the RAM 2 and band data stored in the RAM 2. Out of the above, FIG. 6A illustrates that the data size of the band data of the second band of the second page about to be stored in the RAM 2 is less than or equal to a surplus area of the RAM 2. In this case, determination as “Yes” is made in step S13, and the processing proceeds to step S14.

Furthermore, FIG. 6B illustrates that the data size of band data of the ninth band of the first page about to be stored in the RAM 2 is larger than a surplus area of the RAM 2. In this case, determination as “No” is made in step S13, and the processing proceeds to step S15. Similarly, FIG. 6C illustrates that the data size of band data of the second band of the second page about to be stored in the RAM 2 is larger than a surplus area of the RAM 2. In this case, determination as “No” is made in step S13, and the processing proceeds to step S15.

If it is determined in step S13 that the data size of band data about to be stored in the RAM 2 is less than or equal to a surplus area of the RAM 2 (step S13: Yes), and the processing proceeds to step S14, the memory controller 52 stores and controls the band data in the RAM 2. As a result, the processing of the flowchart of FIG. 5 is completed, and the processing proceeds to step S3 of the flowchart of FIG. 3. Note that in this case, as will be described later, the sheet recovery information set to “execute the sheet recovery operation” as the default setting is not rewritten.

On the other hand, if it is determined in step S13 that the data size of band data about to be stored in the RAM 2 is larger than a surplus area of the RAM 2 (step S13: No), the processing proceeds to step S15. In step S15, the analyzer 53 determines whether the band data that is currently to be stored in the RAM 2 has the earliest order of acquisition out of band data stored in the RAM 2, that is, whether the band data that is currently to be stored in the RAM 2 is of the same page as a page of band data indicated to have the earliest order information out of band data stored in a page memory and is not yet erased as of the time of step S15. Note that the band data having the earliest order of acquisition (being at the head) is determined by examining band data with the smallest band ID among band data having the smallest page number of the order information.

When band data having the earliest order of acquisition among the band data stored in the RAM 2 is of the same page as a page of band data currently to be stored in the RAM 2 at the time of performing the processing of step S13, printing cannot be continued unless a surplus area is formed. Therefore, the memory controller 52 stores and controls the currently acquired band data in the surplus area formed by erasing the band data having the earliest order of acquisition from the RAM 2. FIG. 6B illustrates an example of such a case. In the case of the example illustrated in FIG. 6B, among band data stored in the RAM 2, band data having the earliest order of acquisition is band data of the first band of the first page. Meanwhile, band data currently to be stored in the RAM 2 is band data of the ninth band of the first page. That is, the both are of the same page. In this case, the memory controller 52 erases the band data having the earliest order of acquisition from the RAM 2 to secure a large surplus area in step S16. Then in step S17, the memory controller 52 stores and controls the band data in the surplus area secured in the RAM 2.

Explaining the processing of steps S16 and S17 using the example of FIG. 6B, the memory controller 52 erases the band data of the first band of the first page stored in the RAM 2. As a result, a surplus area is formed in which the surplus area originally present and the surplus area formed by erasing the band data of the first band of the first page area added. The memory controller 52 stores and controls the band data of the ninth band of the first page in the surplus area larger than the band data of the ninth band of the first page currently to be stored.

Note that when a surplus area larger than band data currently to be stored is not formed even if the band data having the earliest order of acquisition is erased, the memory controller 52 also erases band data having the second earliest order of acquisition of the same page. That is, the memory controller 52 sequentially erases band data of the same page from band data having earlier order of acquisition until a surplus area larger than the band data currently to be stored is formed. Then, when a surplus area larger than the band data currently to be stored is formed, the memory controller 52 stores and controls the band data in this surplus area.

In this manner, when the band data having the earliest order of acquisition among band data of the same page is erased and the processing of storing currently acquired band data is performed, a part of band data of the same page is lost, and thus sheet recovery of the page cannot be executed. As described above, the sheet recovery information indicating whether to execute the sheet recovery operation is set to the “setting to execute sheet recovery” as the default. Therefore, the memory controller 52 rewrites the sheet recovery information of the RAM 2, in which the “setting to execute sheet recovery” is made, to sheet recovery information of “setting not to execute sheet recovery” in step S18. As a result, when jam occurs and then is canceled, it is possible to smoothly shift to the operation of “setting not to execute sheet recovery” which will be described later.

On the other hand, if the band data of the earliest order of acquisition stored in the RAM 2 is of a page different from the page of the band data currently to be stored in the RAM 2 in step S15, the memory controller 52 stays in a stand-by state of writing band data to the RAM 2 until printing of all band data of the page to which the band data of the earliest order of acquisition belongs is completed.

That is, in the case of the example of FIG. 6C, band data of the earliest order of acquisition is band data of the first band of the first page. Meanwhile, band data currently acquired is band data of the second band of the second page different from the first page. When printing processing of band data of the first band to the twentieth band of the first page is completed, the memory controller 52 erases the band data of the first band to the twentieth band of the first page from the RAM 2. Therefore, until the printing of all the band data of the first page is completed, the memory controller 52 stays in the stand-by state of writing band data to the RAM 2. Then, when printing of all the band data of the first page is completed, the memory controller 52 erases all the band data of the first page from the RAM 2 and writes the band data of the second band of the second page in a surplus area thereby formed in the RAM 2. As a result, when a jam occurs and then is canceled, it is possible to smoothly execute sheet recovery on the basis of the “setting to execute sheet recovery” which is the default setting.

(Sheet Recovery Operation)

Next, the sheet recovery operation at the time of releasing a print error after the start of printing, such as jam, will be described with reference to a flowchart of FIG. 7. FIG. 7 is a sub-flowchart after a print error has occurred after the start of printing in step S7 in FIG. 3. Upon detecting occurrence of a jam, the jam detector 54 displays a message indicating occurrence of the jam, such as “Please remove a logged paper.” on the operation panel 7, for example. Another message relating to another print error (cover open after the start of printing, or toner runout during printing) may be displayed. With this message, a user recognizes occurrence of the print error and releases the print error such as manually removing the clogged paper, closing the cover, or replacing a toner with a new container. As a result, the error state is released, and the flowchart of FIG. 7 is started, and processing starts from step S21. Note that the processing may be started at any timing after occurrence of the print error such as at the time of occurrence of the print error instead of the time when the error is released to change the setting as to whether to perform sheet recovery.

In step S20, the print error is released. The following is described with a jam as an example of a print error. In step S21, the analyzer 53 refers to the sheet recovery information stored in the RAM 2 to determine whether setting to execute sheet recovery is made. Capability of determining that the setting to execute sheet recovery (step S21: Yes) is made means that band data of a page printing of which has failed is stored in the RAM 2. In this case, the memory controller 52 reads the band data of the page printing of which has failed from the RAM 2 in step S22. Then, the engine controller 55 performs print control of the plotter engine 8 on the basis of the band data read from the RAM 2. As a result, it is possible to perform recovery printing (sheet recovery) of the page printing of which has failed.

Meanwhile, when the “setting not to execute sheet recovery” is made (step S21: No) after performing the rewriting processing of the default setting described above in step S18, the analyzer 53 refers to the print information stored in the RAM 2 in step S23 to determine whether there is a command, indicating that the page is the last page, added to print information of the last page, thereby determining whether the page printing of which has failed is the last page.

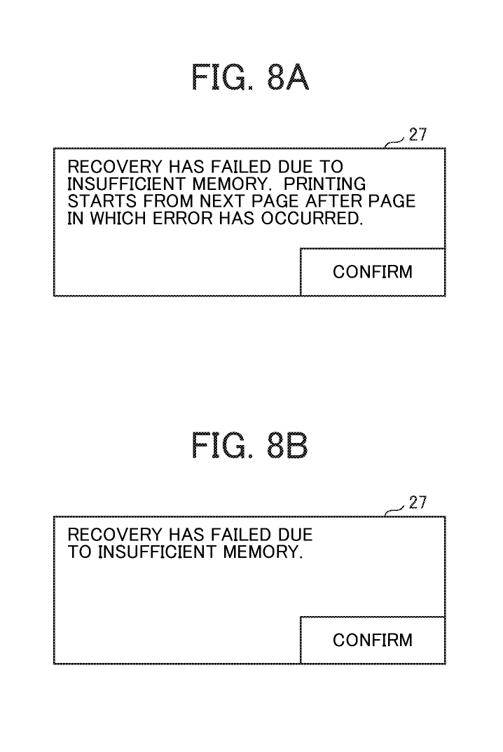

If it is determined that the command indicating that the page is the last page is not added to the print information stored in the RAM 2 and that the page printing of which has failed is not the last page (step S23: No), the processing proceeds to step S24. As described above, in the case of the “setting not to execute sheet recovery”, a part of all the band data for one page is erased from the RAM 2. Therefore, the sheet recovery operation cannot be executed. In this case, the display controller 56 transmits a first error message notifying a user that recovery is not performed such as “Recovery has failed due to insufficient memory. Printing starts from next page after page on which error has occurred.” as illustrated in FIG. 8A to an operation unit and displays the first error message on the operation panel 7 of the operation unit.

With this first error message, the user can recognize that recovery is not executed, and thus the page printing of which has failed is printed again. As a result, even when printing fails and sheet recovery is not executed, it is possible to prevent inconvenience that a missing page occurs as much as possible.

On the other hand, if it is determined that the command indicating that the page is the last page is added to the print information stored in the RAM 2 and that the page printing of which has failed is the last page (step S23: Yes), the processing proceeds to step S25. As described above, in the case of the “setting not to execute sheet recovery”, a part of the band data of the page printing of which has failed is erased from the RAM 2. Therefore, sheet recovery cannot be executed. In this case, the display controller 56 transmits a second error message notifying a user that recovery is not performed such as “Recovery has failed due to insufficient memory.” as illustrated in FIG. 8B to the operation unit and displays the second error message on the operation panel 7 of the operation unit.

This allows the user to recognize that sheet recovery is not executed, and thus the last page in which the jam has occurred is printed again. Therefore, even when printing fails and sheet recovery is not executed, it is possible to prevent inconvenience that a missing page occurs as much as possible.

### Effects of First Embodiment

As is clear from the above explanation, when acquiring band data, the image forming device according to the first embodiment compares the data size of the acquired band data and the size of the surplus area of the RAM 2 for storing the band data. If the data size of the band data is smaller than or equal to the size of the surplus area of the RAM 2, the acquired band data is stored in the RAM 2 as it is, and sheet recovery is executed when the jam is canceled.

On the other hand, if the data size of the band data is larger than the size of the surplus area of the RAM 2, it is determined whether the acquired band data and band data stored in the RAM 2 are of the same page. If both of the band data are of the same page, the band data stored in the RAM 2 is erased from band data of an earlier order of acquisition to enlarge the surplus area, and the acquired band data is stored. Erasing a part (or all) of band data of the same page disables execution of sheet recovery, and thus an error message indicating that sheet recovery cannot be performed is notified to the user. This allows the user to recognize that sheet recovery is not executed, and thus the last page printing of which has failed is printed again. Therefore, even when a jam occurs and sheet recovery is not executed, it is possible to prevent inconvenience that a missing page occurs as much as possible.

On the other hand, if the data size of band data is larger than the size of the surplus area of the RAM 2, and the acquired band data and the band data stored in the RAM 2 are not of the same page, writing of the acquired band data to the RAM 2 is stopped until printing of a page preceding the page printing of which has failed is completed (standby of writing). Then, in a surplus area formed by erasing band data of the page preceding the page printing of which has failed from the RAM 2 when printing of the page preceding the page printing of which has failed, the currently acquired band data is written. As a result, band data can be sequentially stored in the RAM 2, and sheet recovery can be executed after a jam is canceled even when the jam occurs.

As described above, in the image forming device according to the first embodiment, even when the RAM 2 has a small capacity, it is possible to execute sheet recovery of the printed material as much as possible to prevent a printed page from being missed. It is also possible to reduce inconvenience that it is difficult for a user to recognize a missing page when sheet recovery cannot be performed.

### Second Embodiment

Next, an image forming device according to a second embodiment will be described. In the case of the image forming device according to the first embodiment, whether to perform sheet recovery is determined on the basis of the data size of band data and the size of a surplus area of the RAM 2. Meanwhile in the image forming device according to the second embodiment, in order to determine whether to perform sheet recovery, for example, a memory such as the ROM 3 stores a determination table indicating a list of print setting information and correspondence relationships among combinations of print setting information and whether to perform (to set or to cancel) sheet recovery. Then, by referring to the determination table on the basis of print setting of the acquired band data, it is determined whether to perform sheet recovery at the time of canceling a jam. Note that the aforementioned first embodiment and the second embodiment described below are different only in this point. Therefore, only a difference between the two will be described below, and redundant explanation will be omitted.

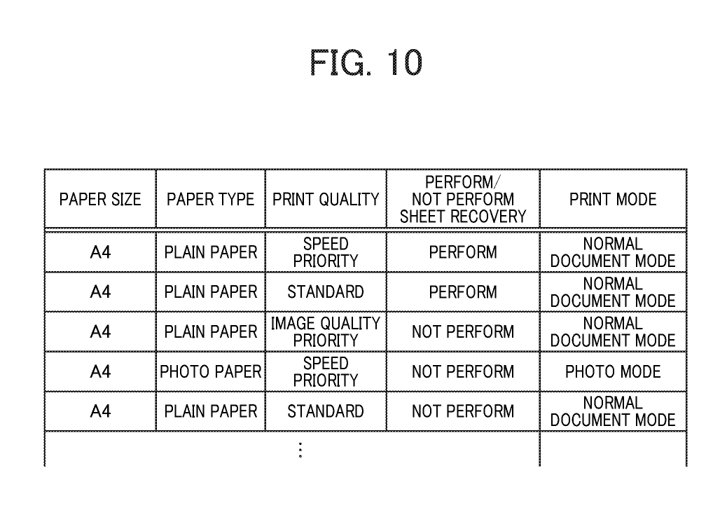

FIG. 9 is a flowchart for explaining determination operation as to whether to perform sheet recovery based on print setting information in the image forming device according to the second embodiment. Note that FIG. 9 is a sub-flowchart at the time of acquiring the print setting information in step S0 in FIG. 3 and thereafter. FIG. 10 is a determination table indicating a list of correspondence relationships among combinations of various print setting information for determining whether to perform sheet recovery and whether to perform (to set or to cancel) sheet recovery stored in a memory such as a ROM 3 (one example of a determination table stored in an information memory). In step S31 of the flowchart of FIG. 9, an analyzer 53 detects print setting information (here, print mode) as a determination basis from page information (see the page information 63 in FIG. 4) of a page to which the acquired band data belongs. As the print mode, for example, a photograph mode, a normal document mode, or another modes is detected. The print setting information as a determination basis may be information representing a paper size, a paper type, or print quality, or other information other than a print mode.

Next in step S32, the analyzer 53 determines whether print setting or a combination of print setting results in performing sheet recovery. Specifically, on the basis of the determination table illustrated in FIG. 10 stored in the memory such as the ROM 3, whether to perform sheet recovery is determined. In the determination table, print setting information (information indicating print setting such as the print mode, the paper size, the paper type, or print quality), combinations thereof, and sheet recovery performance information indicating whether to perform (to set or to cancel) sheet recovery, which are associated with one another. For example, for a combination of print settings of a paper size of A4 size, a paper type of plain paper, and print quality of speed priority printing, sheet recovery performance information of “perform” sheet recovery is associated. For a print mode of a paper size of A4 size, a paper type of plain paper, and print quality of image quality priority printing, sheet recovery performance information of “not perform” sheet recovery is associated.

By referring to the determination table illustrated in FIG. 10 on the basis of the print setting detected in step S31, the analyzer 53 determines whether to perform sheet recovery from the determination table for a combination (row) of print settings including the detected print settings (each item of the table) (step S32). If it is determined by the analyzer 53 to perform sheet recovery (step S32: Yes), the memory controller 52 stores and controls the currently acquired band data in the RAM 2 as it is in step S33. Since the default setting is to perform sheet recovery, sheet recovery setting is not changed. Therefore, whether to perform sheet recovery can be also referred to as whether to set or to cancel (ON/OFF) sheet recovery.

On the other hand, if the analyzer 53 determines not to perform sheet recovery, it means that a surplus area of the RAM 2 is insufficient with respect to the acquired band data, and thus there is a high possibility that all the band data for one page cannot be stored in the page memory. Note that the determination table does not indicate whether an area would be actually insufficient but is determined in advance, for example, that a photograph mode has a large data volume and thus an area would be insufficient. Therefore, if the analyzer 53 determines not to perform sheet recovery (step S32: No), the memory controller 52 erases band data having the earliest order of acquisition to enlarge a surplus area of the RAM 2 (step S34) and stores and controls the currently acquired band data in the enlarged surplus area (step S35). The memory controller 52 further rewrites the sheet recovery setting information of the RAM 2, which is the “setting to execute sheet recovery” as the default, to the sheet recovery setting information of the “setting not to execute sheet recovery” to cancel the setting (step S36). Note that the cancellation of the sheet recovery setting in S36 may be performed before S34 and S35 (immediately after the determination in S32).

Note that respective processing in steps S33 and S34 to S36 are similar to the respective processing in step S14 and steps S15 to S18 in the flowchart of FIG. 5. For details, refer to the explanation on the respective processing of steps S14 and S15 to S18 in the flowchart of FIG. 5.

### Effects of Second Embodiment

Since the image forming device according to the second embodiment uses a determination table for determining whether sheet recovery is possible, laborious calculations can be omitted for determining whether sheet recovery is possible. This enables prompt determination as to whether sheet recovery is possible and obtaining similar effects to the effects of the aforementioned embodiment.

### Third Embodiment

Next, an image forming device according to a third embodiment will be described. The image forming device according to the third embodiment is an example of performing a preliminary determination processing as to whether to perform sheet recovery on the basis of predetermined “recovery NG modes” before performing the main determination processing as to whether to perform sheet recovery. That is, the image forming device according to the third embodiment first performs the preliminary determination processing of determining whether a predetermined condition, indicating high image quality printing requiring a memory area of print information of a predetermined amount or more in a memory such as a RAM 2, is satisfied. Next, on the print information determined as not corresponding to the predetermined condition by the preliminary determination processing, the main determination processing of determining whether to perform the sheet recovery processing is performed on the basis of at least a paper size and print quality. Note that the aforementioned respective embodiments and the third embodiment described below are different only in this point. Therefore, only a difference among the embodiments will be described below, and redundant explanation will be omitted.

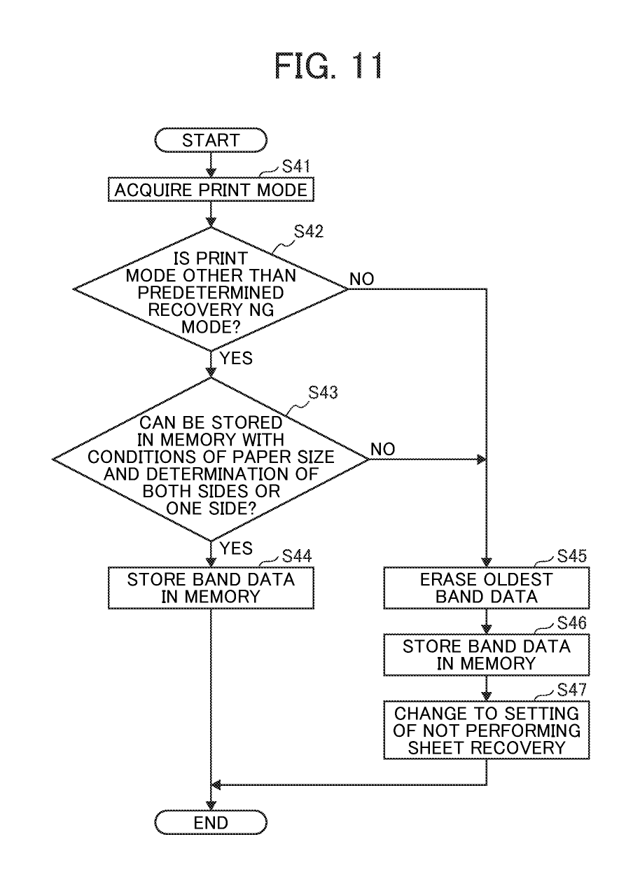

FIG. 11 is a flowchart illustrating a flow of determination operation as to whether to perform sheet recovery in the image forming device according to the third embodiment. As described above, the determination as to whether to perform sheet recovery is executed after obtaining print information in step S0 of FIG. 3 or after storing print information including band data in the RAM 2 in step S2.

In step S41 of the flowchart of FIG. 11, an analyzer 53 detects, from page information (see the page information 63 in FIG. 4) of a page to which the band data included in the print information acquired from an external device 10 illustrated in FIG. 1, print setting information as a determination basis (here a print mode). Although this is merely an example, the analyzer 53 detects information such as the paper size, the paper type, print quality, and double-sided/one-sided determination data as a print mode.

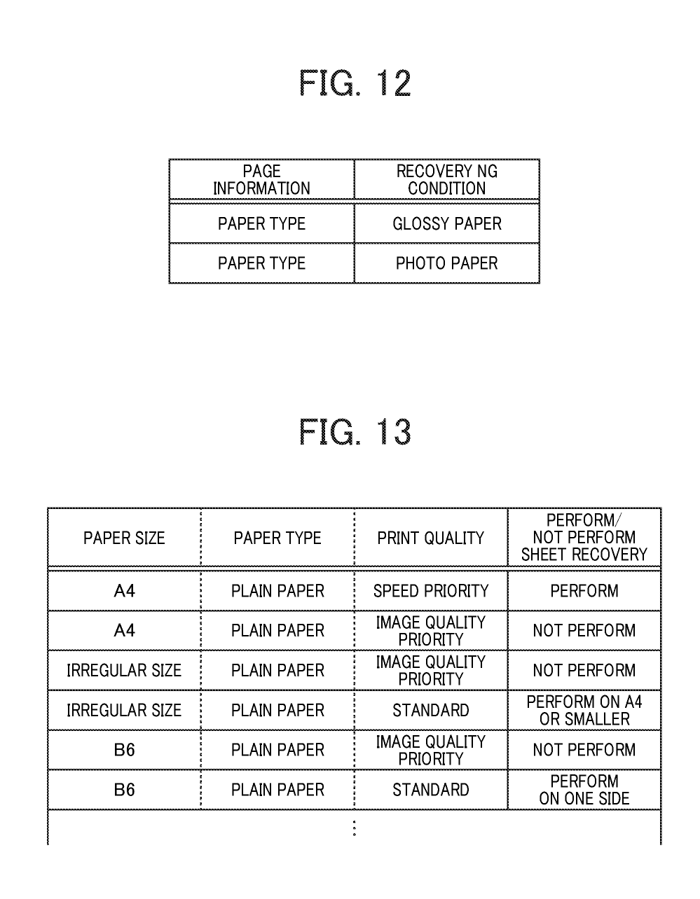

Next in step S42, the analyzer 53 determines whether a print mode is a mode other than the predetermined recovery NG modes. The recovery NG modes indicate a print mode in which it is determined not to perform sheet recovery when it is necessary to store a large volume (more than a predetermined volume) of print information in the RAM 2. Specifically, the determination as to whether one of the predetermined recovery NG modes is made performed on the basis of the list of recovery NG modes illustrated in FIG. 12 and page information in a print mode. The list of recovery NG modes is stored in the memory such as the ROM 3, for example.

FIG. 12 illustrates an example in which the recovery NG mode is set when the paper type is “glossy paper” or “photo paper”. That is, “glossy paper” or “photographic paper” is used for fine drawing, and thus the volume of print information used for drawing also increases. Therefore, when sheet recovery is performed, a memory area capable of storing a large volume of print information in the RAM 2 is required, and in the case where the image forming device includes a RAM 2 of a small-capacity, execution of sheet recovery becomes difficult.

Therefore, by referring to the list of recovery NG modes stored in the ROM 3, the analyzer 53 recognizes the paper type on which sheet recovery is not executed. When the print mode of the print information acquired from the external device 10 designates a paper of “glossy paper” or “photograph paper” (step S42: No), the analyzer 53 proceeds the processing to step S45 (preliminary determination processing). Alternatively, when the print mode of the print information acquired from the external device 10 designates a paper other than “glossy paper” or “photograph paper” (step S42: Yes), the analyzer 53 proceeds the processing to step S44.

If the processing proceeds to step S43 with a print mode other than the predetermined recovery NG mode, the analyzer 53 determines whether the print information can be stored in the RAM 2. Specifically, as illustrated in FIG. 13, a determination table of sheet recovery based on various print modes is stored in the ROM 3. The determination table of sheet recovery illustrated in FIG. 13 as one example includes the “paper size” such as a A4 size, an irregular size, a B6 size, the “paper type” such as plain paper, the “print quality” such as speed priority, image quality priority, and standard, and whether “to perform sheet recovery” such as to perform, not to perform, perform on A4 or smaller, and perform on one side, which are stored in association with one another. The analyzer 53 detects a condition matching the acquired print information from the determination table of sheet recovery and determines whether the print information can be stored in the RAM 2 (main determination processing).

For example, when the paper size indicated by the print information is an irregular size, the analyzer 53 calculates the information volume of the irregular size on the basis of setting values of the longitudinal size×the lateral size acquired from page information 63 of the print information. When the information volume of the irregular size is less than or equal to the information volume of the A4 size, it is determined whether the acquired print information can be stored in the RAM 2 on the basis of the determination table of sheet recovery illustrated in FIG. 13.

The example of FIG. 13 indicates that, when the paper size is an irregular size, it is basically determined not to perform sheet recovery (print information cannot be stored in the RAM 2); however even if the paper size is an irregular size, when the information volume is less than or equal to the information volume of the A4 size, it is determined to perform sheet recovery (print information can be stored in the RAM 2). In the example of FIG. 13, in the case where the paper size is the B6 size, since the information volume of the print information with respect to the RAM 2 increases when the print quality is “image quality priority”, it is determined that storing the print information in the RAM 2 is not possible (not to perform sheet recovery). In addition, in the case where the paper size is the B6 size, when the print quality is “standard”, since the information volume of the print information with respect to the RAM 2 is not so much, it is determined that storing the print information in the RAM 2 (to perform sheet recovery) is possible for one-sided printing.

When it is determined that the print information can be stored in the RAM 2 (step S43: Yes), in step S44, the memory controller 52 stores band data in the RAM 2 as described above and then terminates the processing of the flowchart of FIG. 11.

On the other hand, if it is determined that the print mode is one of the predetermined recovery NG modes (step S42: No), or if it is determined that the print information cannot be stored in the RAM 2 (step S43: No), and the processing proceeds to step S45, the memory controller 52 performs the processing described in steps S34 to S36 in FIG. 9.

That is, the memory controller 52 erases band data having the earliest order of acquisition to enlarge a surplus area of the RAM 2 (step S45) and stores and controls the currently acquired band data in the enlarged surplus area (step S46). The memory controller 52 further rewrites the sheet recovery setting information of the RAM 2, which is the “setting to execute sheet recovery” as the default, to the sheet recovery setting information of the “setting not to execute sheet recovery” to cancel the setting (step S47).

The image forming device according to the third embodiment as described above performs the preliminary determination processing (step S42) of determining whether a predetermined condition indicating high image quality printing is satisfied on the basis of the “recovery NG modes” before performing the main determination processing as to whether to perform sheet recovery (step S43). As a result, a specific condition of not performing sheet recovery (in the case of high image quality printing in this example) can be determined promptly by only one piece of print setting information (paper type) before the main determination processing (step S43). Moreover, similar effects to the effects of the aforementioned embodiments can also be obtained.

### Fourth Embodiment

Next, an image forming device according to a fourth embodiment will be described. The image forming device according to the fourth embodiment is an example where, in the case of setting not to perform sheet recovery, a user can select whether to resume printing from a page subsequent to a page where a print error has occurred or to cancel a printing job. Note that the aforementioned respective embodiments and the fourth embodiment described below are different only in this point. Therefore, only a difference between the two will be described below, and redundant explanation will be omitted.

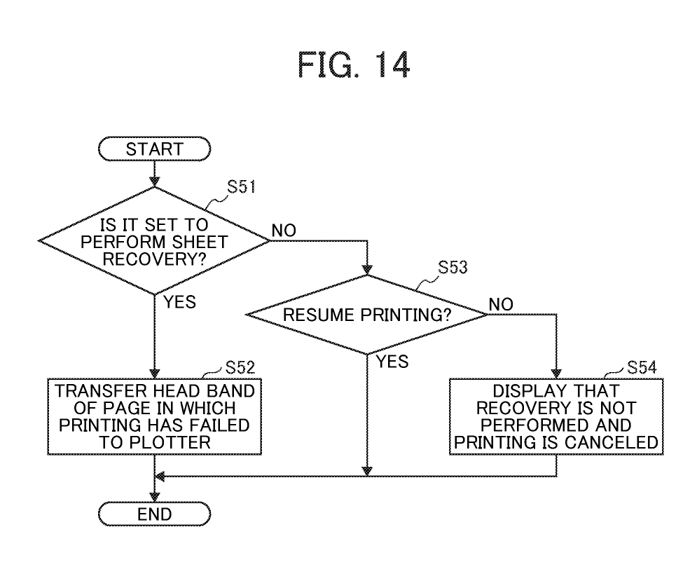

FIG. 14 is a flowchart illustrating a flow of operation according to a determination result as to whether to perform sheet recovery in the image forming device according to the fourth embodiment. As described above, when a print error such as a paper jam is released and a plotter engine 8 illustrated in FIG. 1 resumes printing, an engine controller 55 illustrated in FIG. 2 determines print information to be transferred to a plotter engine 8. At this time, in step S51 of the flowchart of FIG. 14, an analyzer 53 in the image forming device according to the fourth embodiment determines whether to perform sheet recovery on the basis of the determination table illustrated in FIG. 10 as described above. In the case of setting to perform sheet recovery (step S51: Yes), the processing proceeds to step S52, and the memory controller 52 stores and controls band data at the head of a page where the print error has occurred in a RAM 2. As a result, the page in which the print error has occurred is printed again by the plotter engine 8 (sheet recovery is performed).

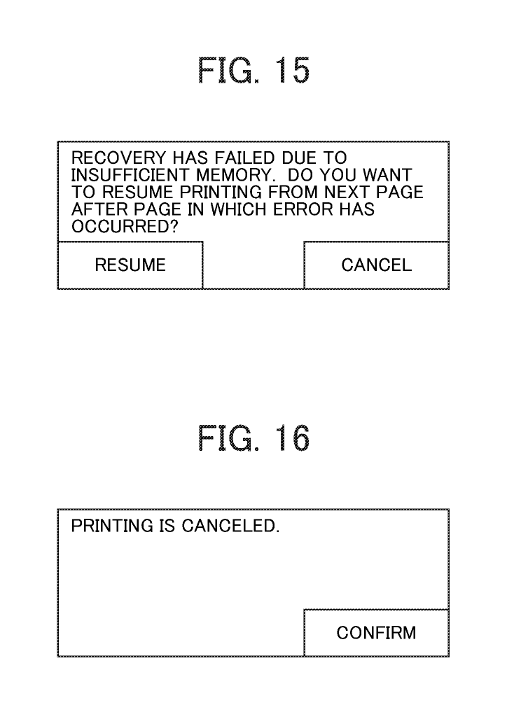

On the other hand, if it is determined as the setting not to perform sheet recovery in step S51 (step S51: No), the processing proceeds to step S53. In step S53, a display controller 56 illustrated in FIG. 2 displays, on an operation panel 7, a message inquiring whether to resume printing from a next page such as “Recovery has failed due to insufficient memory. Do you want to resume printing from the next page after a page in which the error has occurred?” as illustrated in FIG. 15. When a user views this message and wishes to resume printing from the next page, the user operates the “resume” button illustrated in FIG. 15. When this “resume” button is operated, the engine controller 55 controls the plotter engine 8 to resume printing from the page subsequent to the page where the print error has occurred.

On the other hand, if the user does not wish to resume printing from the next page, the user operates a “cancel” button illustrated in FIG. 15. When this “cancel” button is operated, the display controller 56 displays, on the operation panel 7, a message indicating that printing is canceled such as “Printing is canceled.” as illustrated in FIG. 16, for example. Then, the engine controller 55 cancels printing and terminates the processing of the flowchart of FIG. 14. Note that the message is displayed on a window screen displayed on the operation panel, and the “resume” and “cancel” buttons are included in the same window screen and thereby displayed.

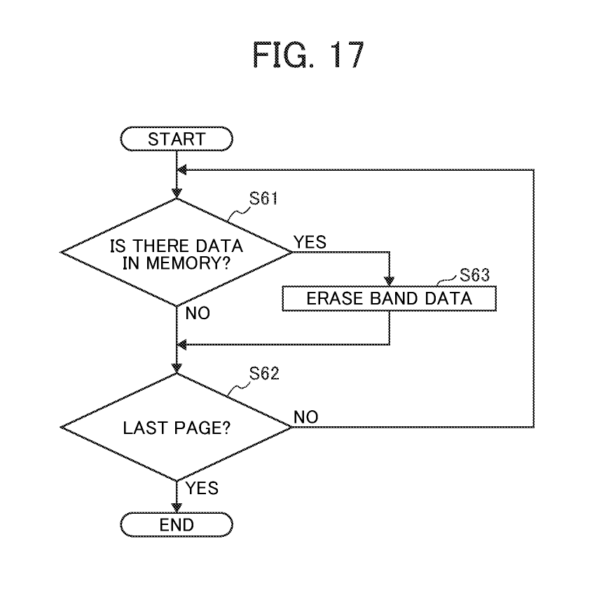

FIG. 17 is a flowchart for explaining operation of erasing band data of a print job in which a print error has occurred from the RAM 2 when cancellation of printing from the next page is designated in step S53. When cancellation of printing is designated by the user, the memory controller 52 determines whether the band data of the print job in which the print error has occurred exists in the RAM 2 in step S61.

When the band data of the print job in which the print error has occurred is present in the RAM 2 (step S61: Yes), the memory controller 52 erases the band data of the print job in the RAM 2 in which the print error has occurred in step S63 and advances the processing to step S62. In step S62, the memory controller 52 determines whether data up to the last band data of the last page of the print job in which the print error has occurred has been erased. That is, in step S62, the memory controller 52 determines whether all the band data of the print job in which the print error has occurred has been erased from the RAM 2.

If it is determined that not all the band data of the print job in which the print error has occurred has been erased from the RAM 2, the memory controller 52 returns the processing back to step S61 and repeatedly executes erasing processing of the band data of the print job, in which the print error has occurred, remaining in the RAM 2 until the last band data of the last page of the print job in which the print error has occurred is erased.

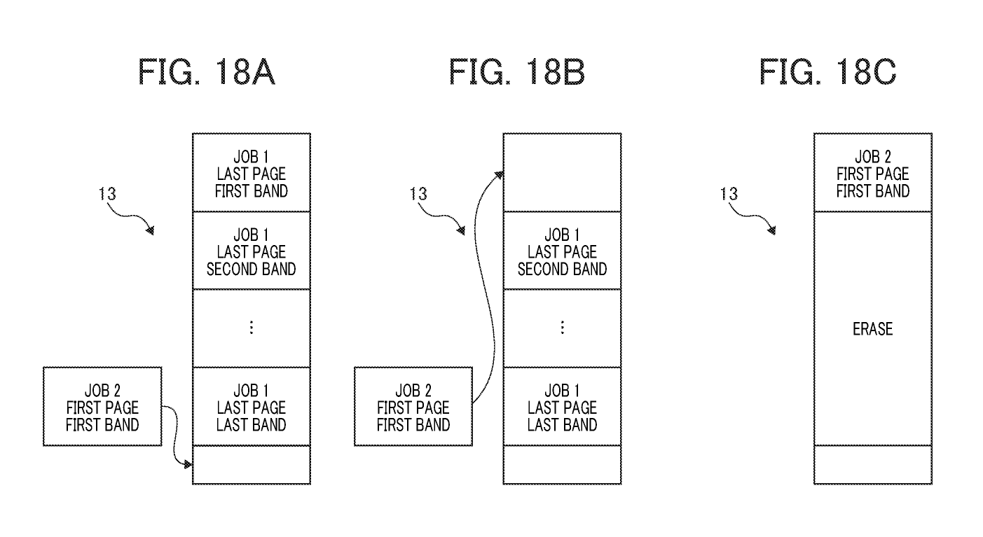

More specifically describing such erasing processing, for example in the example of FIG. 18A, “job 1” is a print job in which a print error has occurred and represents a print job designated by a user to cancel printing of the job. Furthermore, “job 2” represents print information of a print job to be printed next. The example of FIG. 18A illustrates a state where a print error has occurred and band data from the first band to the last band of the last page of “job 1” of which printing has been canceled by a user remains in the RAM 2, and thus a surplus area for storing the band data of the first band of the first page of job 2 to be printed next does not remain in the RAM 2.

In this case, the memory controller 52 executes the processing of steps S61 and S63 of the flowchart of FIG. 17 to first erase the band data of the first band of the last page of job 1. Then, as illustrated in FIG. 18B, the memory controller 52 stores and controls band data of the first band of the first page of new job 2 in a surplus area of the RAM 2 formed by erasing the band data of the first band of the last page of job 1.

Next, the memory controller 52 executes the processing of steps S61 to S63 in the flowchart of FIG. 17 to erase all the band data of the last pages of job 1 remaining in the RAM 2 as illustrated in FIG. 18C.

In the image forming device according to the fourth embodiment as described above, in the case of the setting not to perform sheet recovery, a user can select whether to resume execution of a print job from a page subsequent to a page where a print error has occurred or to cancel the print job in which the print error has occurred. Therefore, it is possible to shift to printing operation in accordance with the user's preference such as cancellation of the print job or resumption of printing from the next page after the page in which the print error has occurred. Moreover, similar effects to the effects of the aforementioned embodiments can also be obtained.

### Fifth Embodiment

Next, an image forming device according to a fifth embodiment will be described. The image forming device according to the fifth embodiment is an example where, when sheet recovery cannot be performed (and in the case of the setting not to perform sheet recovery) due to an insufficient surplus area of the RAM 2, a “missing-page indication page” indicating that a page is missing is printed, and the occurrence of a missing page is clearly indicated to a user. Note that the aforementioned respective embodiments and the fifth embodiment described below are different only in this point. Therefore, only a difference between the two will be described below, and redundant explanation will be omitted.

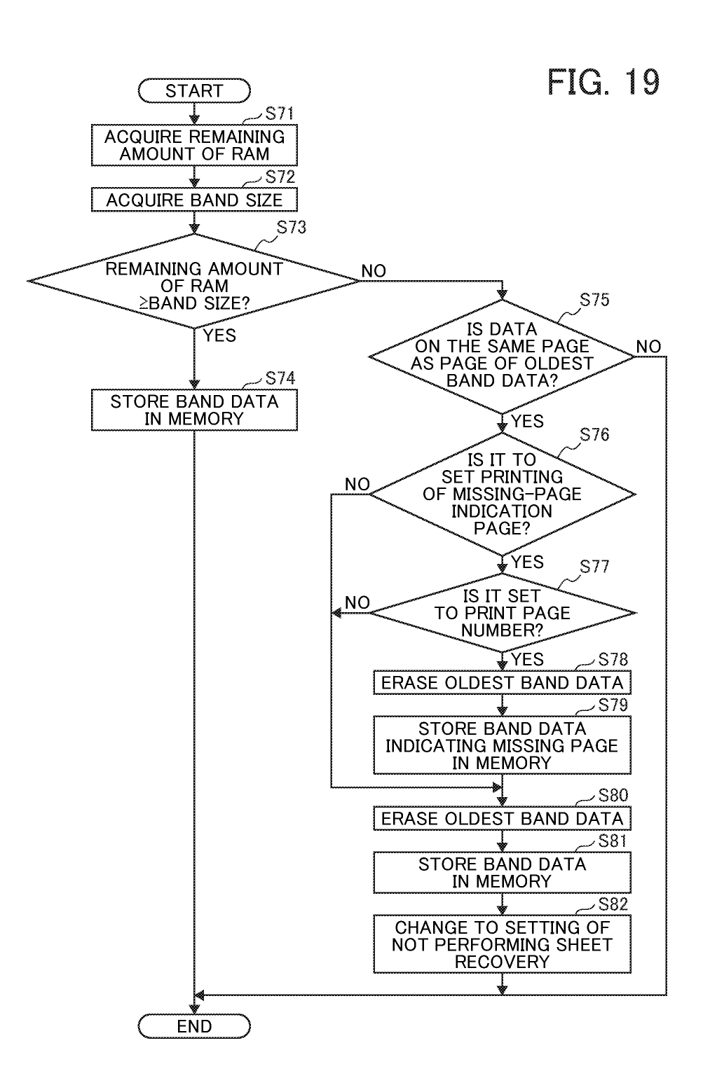

FIG. 19 is a flowchart illustrating a flow of processing of enabling printing of “a missing-page indication page” in the image forming device according to the fifth embodiment. First, in step S71, the remaining amount calculator 51 illustrated in FIG. 2 detects the remaining amount (surplus area) of a memory area of the RAM 2 for storing acquired band data. The remaining amount calculator 51 calculates a difference between the entire memory capacity of the RAM 2 and the size of a memory area currently used by storing print information to calculate the surplus area of the RAM 2.

Next, in step S72, the analyzer 53 detects the data size of band data acquired at the occurrence of a jam. The analyzer 53 calculates the data size of the band data from the print information included in the page information 63 of the print information described with reference to FIG. 4. The analyzer 53 calculates, for example, “paper size (inch)×resolution (dpi)×height of the band (line)” from the paper size, the resolution, and the height information of one band included in the page information 63 in the print information to calculate the data size of the band data. Furthermore, when image data is included in each band data, the analyzer 53 may read the included image data to detect the data size.

Next in step S73, the analyzer 53 determines whether the data size of the band data acquired at the occurrence of the print error is less than or equal to the surplus area of the RAM 2. If the data size of the band data is smaller than or equal to the surplus area of the RAM 2 (step S73: Yes), the memory controller 52 stores and controls the band data in the RAM 2 in step S74 and terminates the processing of the flowchart of FIG. 19.

On the other hand, when the data size of the band data is larger than the surplus area of the RAM 2 (step S73: No), the analyzer 53 determines whether band data currently to be stored in the RAM 2 has the earliest order of acquisition among band data stored in the RAM 2, that is, whether the band data is of the same page as a page of the oldest band data in step S75. Note that the band data having the earliest order of acquisition is determined by examining band data with the smallest band ID among band data having the smallest page number of the order information.

If the oldest band data stored in the RAM 2 is of a page different from the page of the band data currently to be stored in the RAM 2 (step S75: No), the memory controller 52 stays in a stand-by state of writing band data to the RAM 2 until printing of all band data of the page to which the oldest band data belongs is completed. Moreover, when printing of all the band data of the page to which the oldest band data belongs is completed, the memory controller 52 erases all the band data of a page stored in the RAM 2 to store and control the band data which has a larger size than a surplus area of the RAM 2 in the RAM 2.

On the other hand, if the band data about to be stored in the RAM 2 is of the same page as a page of the oldest band data stored in the RAM 2 (step S75: Yes), the analyzer 53 determines whether the setting to perform printing of a “missing-page indication page” is made in step S76. The setting information indicating whether to perform printing of a “missing-page indication page” is stored in a memory such as a ROM 3, and the setting “to perform printing of a missing-page indication page” is made as the default setting. A user can also operate an operation panel 7 to change to setting “not to perform printing of a missing-page indication page”. Setting information after the change is stored in the memory such as the ROM 3 by the memory controller 52.

If it is determined that the setting “not to perform printing of a missing-page indication page” is made (step S76: No), the memory controller 52 erases the oldest band data from the RAM 2 in step S80 to secure a large surplus area. Then in step S81, the memory controller 52 controls to store the band data in the surplus area secured in the RAM 2.

Moreover, when the oldest band data among band data of the same page is erased and the processing of storing currently acquired band data is performed, a part of band data of the same page is lost, and thus sheet recovery of the page cannot be executed. As described above, the sheet recovery information indicating whether to execute the sheet recovery operation is set to the “setting to execute sheet recovery” as the default. Therefore, the memory controller 52 rewrites the sheet recovery information of the RAM 2, in which the “setting to execute sheet recovery” is made, to sheet recovery information of “setting not to execute sheet recovery” in step S82 and terminates the processing of the flowchart of FIG. 19.

On the other hand, if it is determined that the setting to print a missing-page indication page is made (step S76: Yes), the analyzer 53 determines whether setting to print page numbers is made in step S77. Setting information indicating whether to print page numbers is stored in the memory such as the ROM 3. By referring to the setting information, the analyzer 53 determines whether to print page numbers.

If setting not to print page numbers is made (step S77: No), the user cannot recognize a page number of a missing page even if the missing-page indication page is printed, and thus the missing-page indication page is not printed and the processing proceeds to step S80 described above.

Next, in the case of setting to print page numbers (step S77: Yes), the memory controller 52 erases the oldest band data from the RAM 2 in step S78. Then, the memory controller 52 stores and controls “band data for printing a missing-page indication page” in a surplus area secured in the RAM 2 in step S79 and advances the processing to step S80 described above.

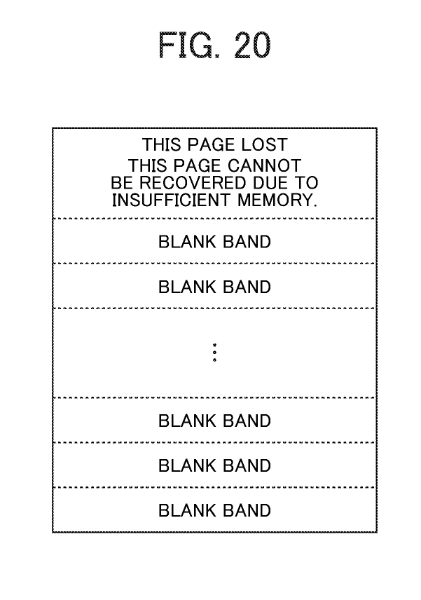

“Band data for printing a missing-page indication page” is for performing printing a message indicating that recovery is impossible such as “THIS PAGE LOST (This page cannot be recovered due to insufficient memory.)” for example as illustrated in FIG. 20 at a predetermined position of a paper of one page while leaving the other space blank.

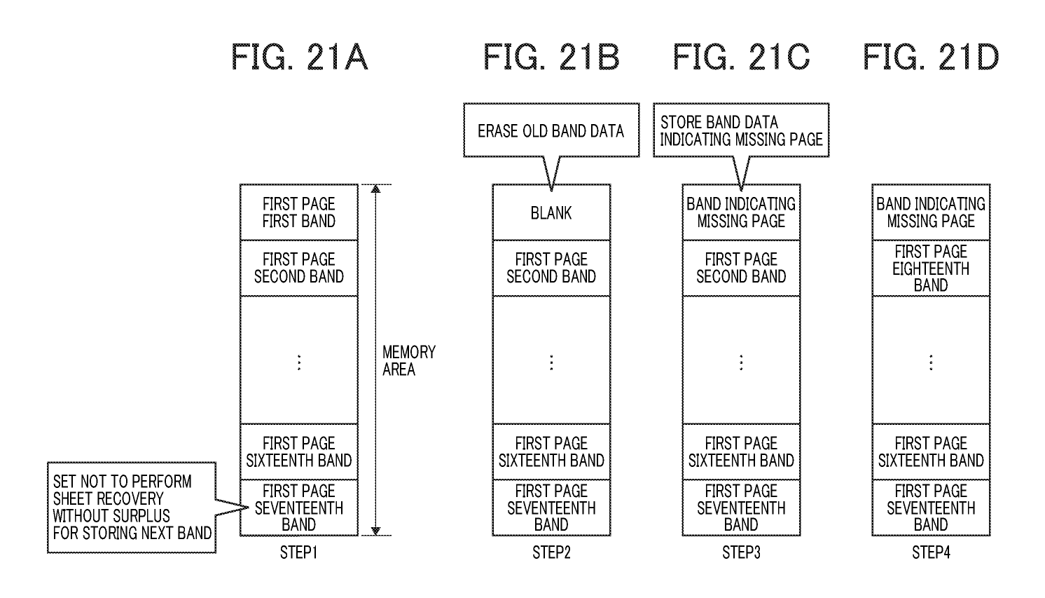

FIGS. 21A to 21D are schematic diagrams illustrating the flow until “band data for printing a missing-page indication page” is stored in the RAM 2 in steps S73 and steps S75 to step S79. That is, as illustrated in FIG. 21A, when it is difficult to store the band data for printing of a missing-page indication page in the RAM 2 since the respective pieces of band data of the first band to the seventeenth band of the first page are currently stored in the RAM 2, the memory controller 52 erases the band data of the first band of the first page, which is the oldest band data, as illustrated in FIG. 21B to secure a surplus area in the RAM 2. Then, as illustrated in FIGS. 21C and 21D, the memory controller 52 stores and controls the band data for printing a missing-page indication page in the surplus area secured in the RAM 2. The band data for printing a missing-page indication page is stored in the ROM 3 in advance. The memory controller 52 stores the band data for printing of the missing-page indication page read from the ROM 3 in the RAM 2.

When the band data for printing a missing-page indication page is stored in the RAM 2, the processing proceeds to step S80, and the memory controller 52 erases the oldest data (=second oldest band data after the band data erased from the RAM 2 in order to store the band data for printing a missing-page indication page) among band data stored in the RAM 2. Then, the memory controller 52 stores and controls the next band data in a surplus area of the RAM 2 formed by the erasure and changes to the setting not to perform sheet recovery in step S82.

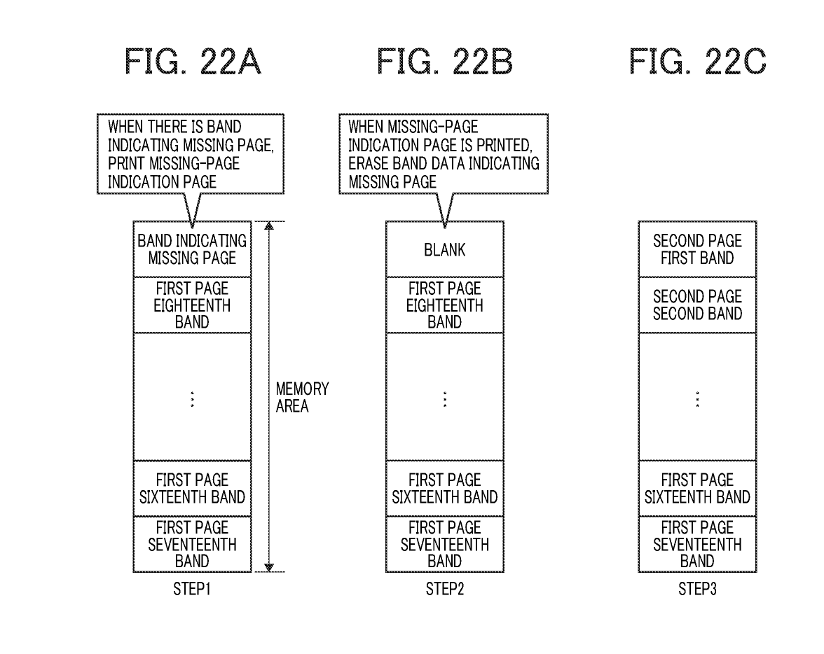

FIGS. 22A to 22C are diagrams illustrating memory contents of the RAM 2 which changes by printing band data for printing a missing-page indication page. In the case where sheet recovery cannot be performed or a missing-page indication page is to be printed, upon recovery from occurrence of a print error, the engine controller 55 determines whether band data for printing a missing-page indication page is stored in the RAM 2. As illustrated in FIG. 22A, when the band data for printing a missing-page indication page is stored in the RAM 2, the engine controller 55 prints a message indicating that recovery cannot be performed at a predetermined position of a paper of one page on the basis of the band data for printing a missing-page indication page as illustrated in FIG. 20 while leaving the other space blank (printing of a missing-page indication page).

When printing of the band data for printing a missing-page indication page is completed, the memory controller 52 erases the band data for printing a missing-page indication page from the RAM 2 as illustrated in FIG. 22B. Then, as illustrated in FIG. 22C, the memory controller 52 stores and controls band data of the next page in a surplus area of the RAM 2 formed by performing such erasing processing. Thereafter, as illustrated in FIG. 22B and FIG. 22C, band data of the next page is sequentially stored in the RAM 2, and printing is continued.

In such an image forming device according to the fifth embodiment, when sheet recovery cannot be performed, a “missing-page indication page” indicating that a page is missing is printed. As a result, a user can view the printed missing-page indication page to recognize that a page is missing and to reprint the missing page. Moreover, similar effects to the effects of the aforementioned embodiments can also be obtained.

For example, in the case of a low-price image forming device, a memory with a small memory capacity may be included in order to reduce the manufacturing cost. When a memory capacity of the memory is small, there are cases where it is impossible to store print information for one page depending on printing conditions, and thus sheet recovery cannot be performed.

In addition, even when sheet recovery is not performed, a printed material having been output appears to have all the pages of the printed material at a glance, and thus the user may take the printed material without noticing the missing page to later recognize the missing page when using the printed material. At this time, there are cases where the user has to reprint in order to obtain a printed material with all the pages included.

As described above, according to at least one of the embodiments of the present disclosure, effects are achieved that it is possible to execute sheet recovery of a printed material as much as possible to prevent a printed page from being missed and that it is also possible to reduce inconvenience that it is difficult for a user to recognize a missing page when sheet recovery cannot be performed.

Lastly, each of the aforementioned embodiments is presented as an example and is not intended to limit the scope of the claimed invention. Each of the novel embodiments can be implemented in various other forms and can include various omissions, substitutions, or modifications within a range not departing from the principles of the disclosure.

In addition, the embodiments and modifications of the embodiments are included in the scope or principles of the disclosure and are also included in the aspects of the disclosure described in the claims and an equivalent scope the aspects. For example, a technician having ordinary knowledge in the field of information processing technology can implement the present invention by a device configured by connecting an application specific integrated circuit (ASIC) or a conventional circuit module.

Moreover, each of the functions described in the respective embodiments described above can be implemented by one or a plurality of processing circuits. Note that a “processing circuit” herein includes a processor programmed to execute each of the functions by software and hardware such as an ASIC or a circuit module designed to execute each of the functions.

What is claimed is:

1. An image forming device comprising:
a memory;
a memory controller to acquire print information transmitted from an external device and to store and control the print information in the memory;
an error detector to detect a print error after start of printing of the print information;
a determiner to determine whether to execute sheet recovery processing to reprint a page in which the print error has occurred;
a print controller to control a printing unit to execute the sheet recovery processing with the print information stored in the memory when a determination result to execute the sheet recovery processing is obtained;
a display; and
a display controller to display on the display a message indicating that the sheet recovery processing is not executed when a determination result not to execute the sheet recovery processing is obtained.

2. The image forming device according to claim 1,
wherein, when the determination result to execute the sheet recovery processing is obtained, the print controller controls the printing unit to execute the sheet recovery processing and then to continuously print a next page of the print information subsequent to the page in which the print error has occurred, and
wherein, when the determination result not to execute the sheet recovery processing is obtained, the print controller controls the printing unit not to print the page in which the print error has occurred and to print the next page after the display controller displays the message on the display.

3. The image forming device according to claim 1,
wherein the print information includes a plurality of pieces of divided print information divided from print information for one page,
wherein the memory controller stores the divided print information in the memory,
wherein the print controller controls the printing unit to execute sheet recovery processing to reprint from one piece of the plurality of pieces of the divided print information at a head of the one page when the print error has occurred, and
wherein the determiner determines whether an additional piece of the divided print information can be stored in the memory with the one piece of the plurality of pieces of the divided print information held at the head of the one page, to determine whether the sheet recovery processing can be executed.

4. The image forming device according to claim 3,
wherein, when it is determined that the divided print information cannot be stored in the memory, the memory controller erases divided print information stored in the memory and having an early order of acquisition to store and control the divided print information in an enlarged surplus area, and
wherein the display controller does not execute the sheet recovery processing and displays on the display a message indicating that printing is resumed from a page subsequent to the page where the print error has occurred.

5. The image forming device according to claim 3,
wherein, when the determiner determines that the divided print information cannot be stored in the memory and when a page to which the divided print information acquired on detection of the print error belongs is divided print information of a next page subsequent to a page to which divided print information already stored in the memory belongs, the print controller executes the sheet recovery processing according to the divided print information already stored in the memory when the image forming device recovers from the print error and thus completes printing of a previous page that is a page already stored in the memory, and then the memory controller stores and controls the divided print information acquired on detection of the print error, in a surplus area formed by erasing divided print information of the previous page.

6. The image forming device according to claim 1,
wherein the print information includes at least one piece of print setting information, and
wherein the determiner determines whether to execute the sheet recovery processing in accordance with the print setting information or a combination of a plurality of pieces of print setting information.

7. The image forming device according to claim 1,
wherein the print information includes at least one piece of print setting information,
wherein the print setting information includes information indicating a print mode, and
wherein the determiner determines whether to execute the sheet recovery processing according to the print mode.

8. The image forming device according to claim 7,
wherein the print mode includes a photograph mode or an image quality priority mode, and
wherein the determiner determines not to execute the sheet recovery processing in the photograph mode or the image quality priority mode.

9. The image forming device according to claim 1,
wherein the determiner performs preliminary determination processing to determine whether a predetermined condition, indicating high image quality printing requiring a memory area of the print information of a predetermined amount or more in the memory, is satisfied and further performs, on the print information determined as not corresponding to the predetermined condition by the preliminary determination processing, main determination processing to determine whether to perform the sheet recovery processing according to at least a sheet size and print quality.

10. The image forming device according to claim 1,
wherein, when the determination result to execute the sheet recovery processing is obtained, the display controller displays, on the display, a message to select whether to resume printing from a next page subsequent to the page in which the print error has occurred or to cancel printing,
wherein, when cancellation of the printing is selected based on the message, the print controller controls the printing unit to cancel the printing, and,
wherein, when resumption of the printing is selected, the print controller controls the printing unit to resume the printing from the next page subsequent to the page in which the print error has occurred.

11. The image forming device according to claim 10,
wherein the memory controller erases the print information of the canceled printing from the memory when cancellation of the printing is selected.

12. The image forming device according to claim 1,
wherein the determination result not to execute the sheet recovery processing is obtained by the determiner, the memory controller stores and controls, in the memory, print information for printing a missing-page indication page indicating that a page is missing, and
wherein the print controller controls the printing unit to print the missing-page indication page according to the print information stored in the memory.

13. The image forming device according to claim 12,
wherein the memory controller erases the print information of the missing-page indication page stored in the memory when printing of the missing-page indication page is completed.

14. An image forming method comprising:
acquiring print information transmitted from an external device and storing the print information in a memory;
detecting a print error after start of printing of the print information;
determining whether to execute sheet recovery processing to reprint a page in which the print error has occurred;
controlling a printing unit to execute the sheet recovery processing with the print information stored in the memory when a determination result to execute the sheet recovery processing is obtained; and
displaying on a display a message indicating that the sheet recovery processing is not executed when a determination result not to execute the sheet recovery processing is obtained.

15. A non-transitory recording medium storing program codes that cause a computer to execute an image forming method, the image forming method comprising:
acquiring print information transmitted from an external device and storing the print information in a memory;
detecting a print error after start of printing of the print information;
determining whether to execute sheet recovery processing to reprint a page in which the print error has occurred;
controlling a printing unit to execute the sheet recovery processing with the print information stored in the memory when a determination result to execute the sheet recovery processing is obtained; and
displaying on a display a message indicating that the sheet recovery processing is not executed when a determination result not to execute the sheet recovery processing is obtained.

16. The recording medium according to claim 15,
wherein the method further comprises:
when the determination result to execute the sheet recovery processing is obtained, controlling the printing unit to execute the sheet recovery processing and continuously print a next page of the print information subsequent to the page in which the print error has occurred; and
when the determination result not to execute the sheet recovery processing is obtained, controlling the printing unit not to print the page in which the print error has occurred and to print the next page after the display controller displays the message on the display.

17. The recording medium according to claim 15,
wherein the method further comprises:
storing a plurality of pieces of divided print information divided from print information for one page in the memory;
controlling the printing unit to execute sheet recovery processing to reprint from one piece of the plurality of pieces of the divided print information at a head of the one page when the print error has occurred; and
determining, by the determiner, whether an additional piece of the divided print information can be stored in the memory with the one piece of the plurality of pieces of the divided print information held at the head of the one page, to determine whether the sheet recovery processing can be executed.

18. The recording medium according to claim 15,
wherein the print information includes at least one piece of print setting information, and
wherein the determining includes determining whether to execute the sheet recovery processing in accordance with the print setting information or a combination of a plurality of pieces of print setting information.

19. The recording medium according to claim 15,
wherein the print information includes at least one piece of print setting information,
wherein the print setting information includes information indicating a print mode, and
wherein the determining includes determining whether to execute the sheet recovery processing according to the print mode.

20. The recording medium according to claim 19,
wherein the print mode includes a photograph mode or an image quality priority mode, and
wherein the method further includes determining not to execute the sheet recovery processing in the photograph mode or the image quality priority mode.
